(19) United States
(12) Patent Application Publication
(10) Pub. No.: US 2002/0112748 A1
(43) Pub. Date: Aug. 22, 2002

(54) Vehicle washing system

(76) Inventor: John H. Niland, Dallas, TX (US)

Correspondence Address: Kenneth R Glaser, Gardere Wynne Sewell LLP, 1601 Elm Street, Suite 3000, Dallas, TX, 75201-4761, US

(21) Appl. No.: 09/789,039

(22) Filed: Feb. 20, 2001

(51) Int. Cl. B60S 3/04

(52) U.S. Cl. 134/58 R; 134/123; 134/100.1

(57) ABSTRACT

A vehicle washing system, particularly adapted for concrete mixer trucks and bulk material tank trucks, includes spaced apart arches having opposed legs and transverse members with arrays of spray nozzles mounted thereon. Longitudinal spray manifolds are mounted midway on the transverse members of each arch to provide suitable washing of rotatable mixer drums and tank trucks. A driver operated control panel is mounted spaced from one of the arches and is provided with selector switches for actuation in accordance with the type of vehicle to be washed for actuating a valve to cause washing fluid and rinse fluid to flow to the respective arches. Washing fluid is conducted to one of the arches by way of a venturi mechanism which inducts a mixture of an acid solution and a surfactant solution into a pressure water stream prior to conducting the washing fluid to the arch.

### FIELD OF THE INVENTION

The present invention pertains to a vehicle washing system particularly adapted for washing concrete mixer trucks and bulk material tanker trucks.

### BACKGROUND

In material transport operations, such as via bulk material haul trucks and concrete mixer trucks, an important operational requirement is washing the vehicle after a loading or unloading operation to remove any material accumulated on the exterior of the vehicle prior to the vehicle re-entering public roadways.

In this regard, vehicle washing systems for the aforementioned types of vehicles typically include a spray nozzle arrangement for spraying a water-based mixture which includes a surfactant and, in many cases, an acid mixed into the spray fluid to thoroughly clean the exterior surfaces of vehicles including tank-type trailers and concrete mixer drums. The surfactant/acid spray is usually followed by a sprayed on water rinse step in the washing process. However, vehicles with elongated tank-type trailers and rotating mixing drums, for example, are difficult to thoroughly clean with conventional vehicle washing equipment known in the prior art.

Another problem associated with vehicle washing systems for vehicles of the type mentioned hereinabove is the need to provide a system which is adapted for effectively washing vehicles of various types. For example, concrete mixer trucks have a tank or mixer drum overall length substantially different from tractor-trailer type tanker trucks or non-articulated, so-called straight bulk material tanker or hauler trucks. In this regard, it is desirable to provide a washing system which is adapted to wash vehicles of various lengths.

The problems associated with prior art vehicle washing systems and the desiderata mentioned above for vehicle washing systems, particularly of the type used to wash concrete mixer and bulk material tank trucks, have been met by the vehicle washing system of the present invention.

### SUMMARY OF THE INVENTION

The present invention provides an improved vehicle washing system for motor vehicles, including concrete mixer trucks, and bulk material tanker and hauler trucks, in particular.

In accordance with one aspect of the present invention, a vehicle washing system is provided which includes at least one arch structure on which are mounted plural spaced apart spray nozzles. The arch is configured to permit drive through of a vehicle such as a concrete mixer truck or bulk material tanker truck. The multiple spray nozzle arch is also provided with a depending longitudinally oriented manifold, including spaced apart spray nozzles, to provide effective washing of elongated bulk material tanks and rotating concrete mixer drums, in particular.

In accordance with another aspect of the present invention, a vehicle washing system is provided which includes at least two spaced apart arches, each arch including plural spray nozzles mounted thereon along opposed sides of the arch and along and depending from a transverse crossbeam member of the arch. Each of the arches preferably includes a longitudinally oriented spray nozzle manifold for discharging high velocity washing fluid onto the top of a bulk material tank type trailer or truck bed and a concrete mixer drum, for example.

In accordance with yet a further aspect of the present invention, a vehicle washing system is provided which is adapted to be controlled to wash vehicles of various lengths, including so-called straight trucks which include concrete mixer drums thereon or bulk material storage tanks thereon as well as motor trucks of the tractor trailer type which have longer bulk material storage tanks thereon.

In accordance with still another aspect of the present invention, a vehicle washing system is provided which is portable and includes two spaced apart arches which may be selectively spaced with respect to each other and may be moved out of a driveway when not in use.

Those skilled in the art will further appreciate the advantages and superior features of the present invention upon reading the detailed description which follows in conjunction with the drawing.

### BRIEF DESCRIPTION OF THE DRAWINGS

FIG. 1 is a perspective view of a vehicle washing system in accordance with the present invention;

FIG. 2 is a detail view taken generally from the line 2-2 of FIG. 1;

FIG. 3 is a generalized schematic diagram of a portion of the vehicle washing system shown in FIG. 1;

FIG. 4 is a perspective view of a driver operated control panel for the washing system of the present invention; and

FIG. 5 is a perspective view of an alternate embodiment of a vehicle washing system in accordance with the present invention.

### DETAILED DESCRIPTION OF PREFERRED EMBODIMENTS

In the description which follows, like elements are marked throughout the specification and drawings with the same reference numerals, respectively. The drawing figures are not necessarily to scale and certain features are shown in general or somewhat schematic form in the interest of clarity and conciseness.

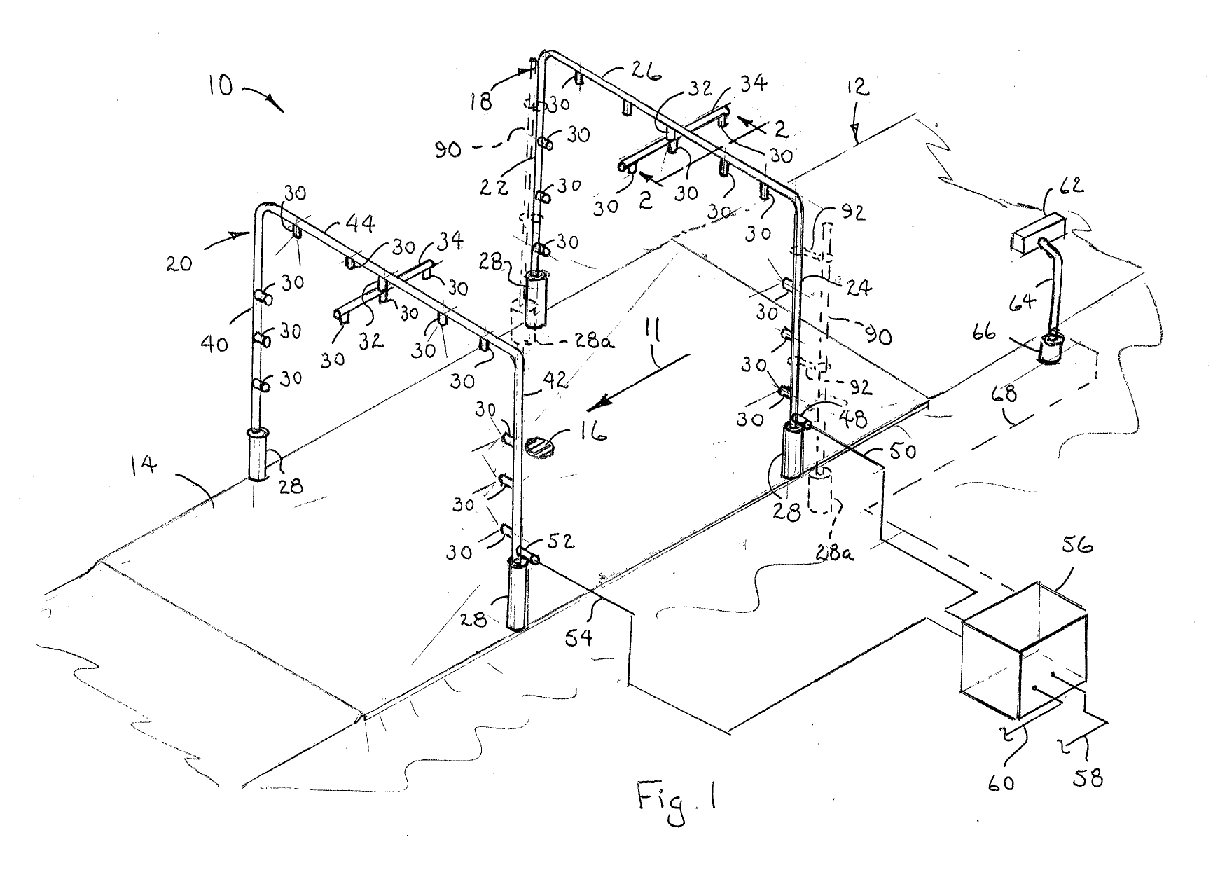

Referring to FIG. 1, there is illustrated a vehicle washing system in accordance with the invention and generally designated by the numeral 10. The vehicle washing system 10 is adapted to be mounted out-of-doors on a suitable driveway 12 which may include a hard surfaced pad of asphalt or concrete 14 suitably sloped to allow collection of washing liquid runoff into a drain 16 for recovery or discharge to a suitable treatment system. The vehicle washing system 10 includes two spaced apart arches 18 and 20. The arches 18 and 20 are preferably formed of hard metal pipe of a suitable diameter. Schedule forty or schedule eighty pipe of a nominal diameter of 0.75 to 2.0 inches is suitable. The arch 18 includes opposed upstanding legs 22 and 24 and a transverse crossbeam member 26 interconnecting the legs 22 and 24 and forming a continuous fluid conduit. Each of the upstanding leg members 22 and 24 is supported at its lower end by a suitable movable anchor member 28 which may comprise a concrete plug, for example. The anchor members 28 may be embedded in the ground if the spacing of the arches 18 and 20 is to be fixed and the system is to have a permanent location. Accordingly, the arch 18 is formed from an assembly of suitable sections of the aforementioned pipe to form the arch which is of sufficient height and width as to allow clearance of conventional over-the-road motor vehicles, such as concrete mixer trucks, straight and tractor trailer type tanker and bulk material hauler trucks, for example. The legs 22 and 24 are each provided with horizontally extending short pipe nipple sections 30 suitably secured, such as by welding, to the upstanding legs 22 and 24, respectively. In like manner, the transverse member 26 of arch 18 also includes spaced apart relatively short downwardly projecting pipe nipple sections 30 suitably welded or otherwise secured to the transverse member 26. Midway between the legs 22 and 24, a depending pipe nipple section 32 is supported on the transverse member 26 and, in turn, supports a longitudinal manifold 34 formed of the same pipe as the rest of the arch 18. The manifold 34 is closed at its opposite ends but includes spaced apart depending pipe nipple sections 30 secured thereto, as shown.

Referring briefly to FIG. 2, each of the pipe nipple sections 30 includes a suitable spray nozzle 38 mounted on the distal end thereof and which may be of a type commercially available. Each spray nozzle 38 is operable to discharge a generally flat fan shaped spray pattern having an included angle “a” of about forty to ninety degrees. A spray nozzle 38 is mounted on each pipe nipple section 30 and is oriented such that the spray pattern emitted from each nozzle is substantially co-planar with the plane of the arch 18. However, the spray nozzles 38 supported on the manifold 34 are oriented to emit a spray pattern which is preferably in a plane normal to the plane of the arch 18 and in a longitudinal direction with respect to the length of a vehicle of the type mentioned hereinabove. Referring to FIG. 1, the normal direction of vehicle travel through the vehicle washing system 10 is indicated by the arrow 11.

The arch 20 is constructed virtually identical to the arch 18 and includes upstanding legs 40 and 42 and an integrally joined transverse member 44. Each of the legs 40 and 42 includes at least three spaced apart integrally joined pipe nipple members 30, each provided with a nozzle assembly 38, as shown by example in FIG. 2. The transverse member 44 also includes spaced apart downwardly projecting pipe nipple members 30, as indicated, and a depending pipe nipple part 32 centrally located on member 44 and supporting a manifold 34. Manifold 34 on arch 20 is oriented longitudinally, generally parallel to arrow 11, preferably centered between the legs 40 and 42 and co-linear with manifold 34 on arch 18. Legs 40 and 42 also form a continuous conduit with transverse pipe member 44, are closed at their lower ends, respectively, and are each supported by a base or pedestal member 28, as shown.

The spray arches 18 and 20 are each connected to a source of washing fluid. Spray arch 18 includes a pipe nipple section 48 connected to the lower end of leg 24 and to a suitable fluid supply conduit 50, FIG. 1. In like manner, leg 42 of arch 20 includes a pipe nipple section 52 disposed adjacent the lower end of leg 42 and suitably connected to a fluid supply conduit 54. Conduits 50 and 54, which are preferably flexible, extend to a fluid supply and control enclosure 56 which is also connected to a source of high pressure water by way of a conduit 58. Conduit 58 may use water from a municipal supply or another source and may require a booster pump interposed the supply line 58 and the enclosure 56 to provide washing fluid at a suitable pressure. Enclosure 56 is also connected to a source of electrical power by way of a cable 60, as shown in FIG. 1.

Control of operation of the vehicle washing system 10 is initiated by the driver of a vehicle to be washed by driving the vehicle to a position such that the driver may, without leaving the cab of the vehicle, access a control panel 62 mounted on a support arm 64 which, in turn, is secured to a suitable base or pedestal member 66 adjacent the driveway 12. An electrical conductor cable 68 extends between control panel 62 and the enclosure 56.

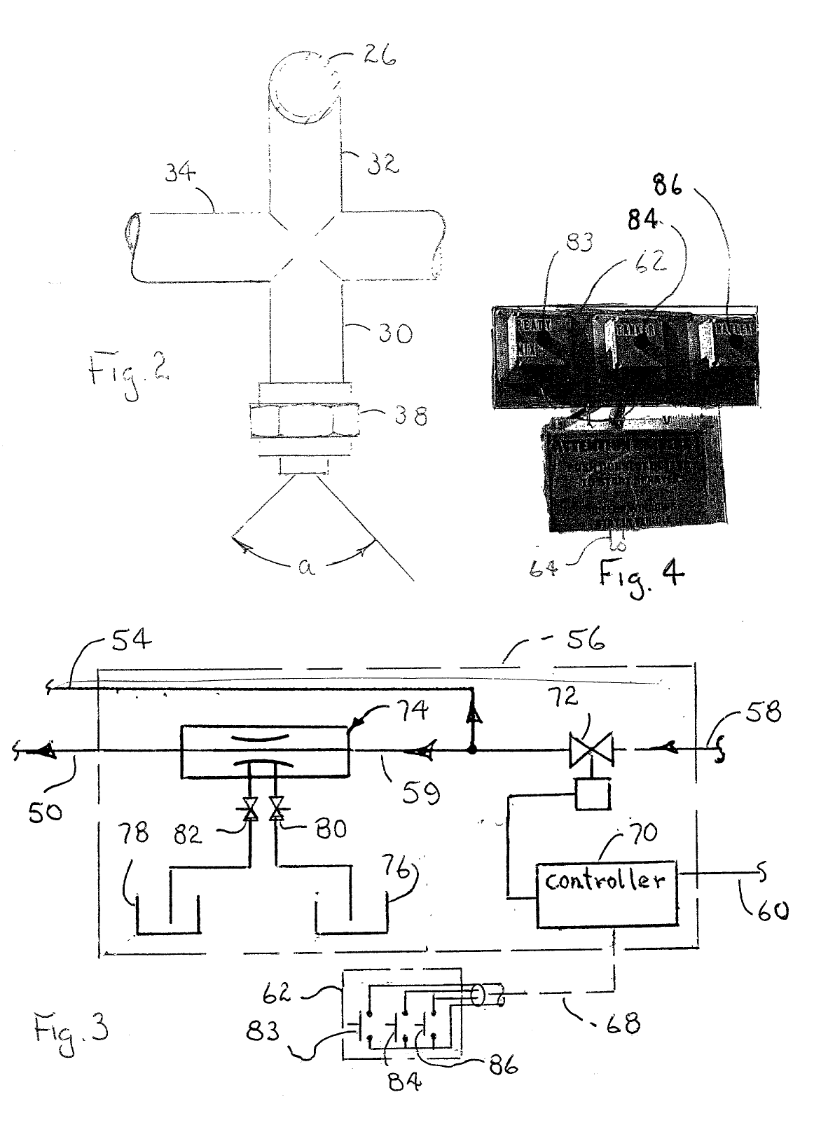

Referring to FIG. 3, the enclosure 56 is adapted to house a suitable controller 70 operably connected to the control panel 62 by way of the control cable 68. Controller 70 is operably connected to a motor operated valve 72 disposed in the high pressure water supply line 58 for controlling flow of washing fluids to the spray arches 18 and 20. Conduit 54 is operably connected to conduit 58 downstream of valve 72 for receiving rinse water directly from conduit 58 through valve 72 for conduction to the spray arch 20 for dispensing directly from all of the pipe nipples 30 on arch 20 and their associated nozzles 38. Conduit 58 is also connected to a high pressure water supply conduit 59 which is connected to a venturi mechanism 74 disposed within the enclosure 56 and connected to the conduit 50. Venturi mechanism 74 is operably connected to a fluid storage tank 76 which may store a quantity of a suitable low concentration acid solution. Venturi mechanism 74 is also operably connected to a storage tank 78 containing a quantity of a surfactant solution. The proportions of acid solution and surfactant solution delivered to the venturi mechanism 74 for entrainment with water supplied through conduit 59 to conduit 50 may be adjusted by suitable throttling valves 80 and 82, as shown in FIG. 3.

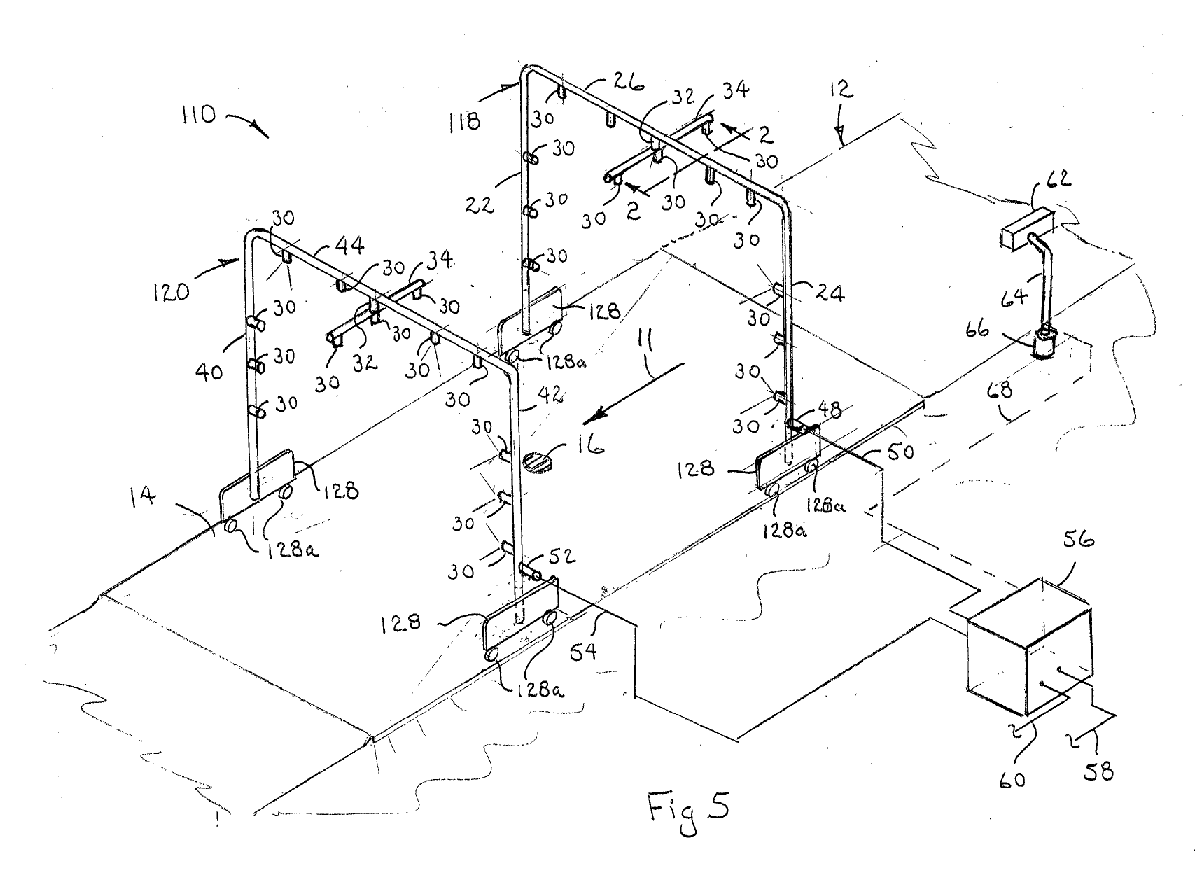

Operation of the controller 70 is initiated by actuation of one of three momentary push button switches 83, 84 and 86 mounted on the control panel 62 for actuation by the driver of a vehicle to be washed. As shown in FIG. 4, each of the switches 83, 84 and 86 is labeled with appropriate indicia to indicate which type of vehicle will be properly washed upon actuation of the associated switch. For example, actuation of switch 83 will cause controller 70 to open valve 72 for a predetermined period of time necessary to wash a concrete mixer truck as the driver of such a truck pulls forward under the arches 18 and 20. In like manner, actuation of switches 84 and 86 will cause controller 70 to open valve 72 for other selected periods of time associated with the times necessary to wash vehicles of different lengths. For example, actuation of switch 84 will cause controller 70 to open valve 72 for a time sufficient to wash a bulk material tractor-trailer tank truck. If switch 86 is actuated controller 70 opens valve 72 for a time sufficient to wash a bulk material hauler truck.

The operation of the vehicle washing system 10 is believed to be readily understandable to one of ordinary skill in the art from the foregoing description. As a vehicle approaches the control panel 62, the driver stops the vehicle and selects the appropriate switch 83, 84 or 86 depending on the type of vehicle to be washed. Upon actuation of the selected switch, the driver is instructed to pull forward under the arches 18 and 20. After a suitable time delay, which commences with actuation of one of the switches 83, 84 and 86, the controller 70 will open valve 72 for a predetermined period of time, depending on which of the aforementioned switches is actuated. As the driver pulls forward at minimum speed (low gear and closed throttle), high pressure water flowing through the venturi mechanism 74 will induct a proportionate flow of acid solution and surfactant solution which will be mixed and sprayed onto the vehicle as it moves under the arch 18. The continuous flow path provided by the hard pipe arch 18 and the manifold 34 connected thereto will provide for a high velocity spray pattern to be emitted from the nozzles 38 associated with each of the pipe nipples 30 of arch 18. Thanks to the longitudinal manifolds 34, rotating drums of concrete mixer trucks will be thoroughly washed and generally cylindrical tanks of bulk material tank trucks will also receive a more thorough washing as the vehicle moves through the arches 18 and 20.

As the vehicle passes under the arch 18 and then under the arch 20, rinse water will be sprayed from nozzles 38 associated with each of the pipe nipples 30 on the arch 20, as well as on the longitudinal manifold 34 of the arch 20, to thoroughly rinse the vehicle. Conduit 54 may also be connected to a suitable venturi mechanism, not shown, and a source of rinse solution, other than water from a conventional municipal water supply, if desired.

Although the arches 18 and 20 may be formed of hard metal pipe, such as schedule forty or schedule eighty steel pipe of a nominal diameter of about 0.75 to 2.0 inches, such a construction of the arches 18 and 20 is substantially self supporting with the assistance of the base members 28 which may comprise cast concrete members encapsulating the lower ends of each of the legs of the arches 18 and 20, as illustrated. However, the arches 18 and 20 may also be made up of flexible fluid conducting hoses supported by suitable framework, not shown. The base members 28 may be permanently affixed at the wash system site or be movable if the distance between the arches 18 and 20 is desired to be changed.

Referring again to FIG. 1, in certain instances, particularly when the spray arch 18 is adapted for pumping an acid solution through the pipe members 22, 24 and 26, it may be desirable to fabricate these pipe members, as well as the nipple sections 30, of a suitable plastic which is acid resistant. In this regard, the arch 18 may not be of sufficient strength as to be self-supporting. Accordingly, the arch 18, as well as the arch 20, may be supported by rigid column supports 90 suitably connected to the upstanding arch leg members 22 and 24 at spaced apart points by suitable connectors 92. The column members 90 may be embedded at their lower distal ends in anchor members 28a, similar to the anchor members 28. Moreover, the anchor members 28a may be embedded in the ground adjacent the driveway 14 if the installation is to be permanent.

Referring now to FIG. 5, an alternate embodiment of a vehicle washing system in accordance with the invention is illustrated and generally designated by the numeral 110. The washing system 110 is characterized by two spaced apart somewhat inverted U shaped spray arches 118 and 120 which are substantially like the arches 18 and 20 and include substantially rigid pipe leg members 22 and 24 and a cross beam member 26 for the arch 118 as well as leg members 40 and 42 and a cross beam member 44 for the arch 120. The lower distal ends of the leg members 22 and 24 are plugged and are suitably mounted on rigid somewhat plate-like support members 128 which include rollers or casters 128a whereby the arches 118 and 120 may be moved onto and off the driveway 14 if desired. Moreover, the spacing between the arches 118 and 120 may be easily modified as required by the types of vehicles being washed by the system 110. In all other respects the vehicle washing system 110 is substantially like the system 10 described above.

Although preferred embodiments of the invention have been described in detail herein, those skilled in the art will recognize that various substitutions and modifications may be made to the invention without departing from the scope and spirit of the appended claims.

What is claimed is:

1. A vehicle washing system comprising:
at least two spaced apart fluid spray arches, each of said arches including spaced apart upstanding legs and transverse members interconnecting said legs, at least said legs including spaced apart spray nozzles disposed thereon for spraying a washing fluid onto a vehicle passing through said arches;
a source of liquid washing fluid connected to one of said arches and a source of liquid rinsing fluid connected to the other of said arches;
control means for conducting washing fluid to said one arch and rinse fluid to said other arch; and
a vehicle driver operated control panel including at least one switch for initiating operation of said washing system when a vehicle is driven under said arches, respectively.

2. The washing system set forth in claim 1 wherein:
said arches are formed of hard pipe and are supported by respective base members connected to respective ones of the legs of said arches.

3. The washing system set forth in claim 1 wherein:
at least one of said arches includes an elongated manifold supported on said transverse member and including plural spray nozzles mounted thereon for generating a longitudinal spray pattern for washing vehicles selected from a group consisting of concrete mixer trucks, bulk material tank trucks and bulk material hauling trucks.

4. The washing system set forth in claim 1 wherein:
said control panel is mounted on a support spaced from one of said arches.

5. The washing system set forth in claim 1 wherein:
said source of washing fluid includes a venturi mechanism, and at least one of an acid solution tank and a surfactant solution tank operably connected to said venturi mechanism through respective conduits, and said venturi mechanism is connected to a source of high pressure water for inducting at least one of acid solution and surfactant solution into high pressure water to form said washing fluid.

6. The washing system set forth in claim 5 wherein:
said control panel is operably connected to said control means for operating a motor operated valve to place said source of high pressure water in communication with said venturi mechanism.

7. The washing system set forth in claim 5 wherein:
one of said arches is operably connected to said source of high pressure water by way of a rinse fluid supply conduit for receiving high pressure water from said source by way of said motor operated valve.

8. The washing system set forth in claim 7 wherein:
said rinse fluid supply conduit is connected to said source of high pressure water between said motor operated valve and said venturi mechanism.

9. The washing system set forth in claim 1 wherein:
said control panel includes plural switches operably connected to said control means for initiating operation of said washing system for a predetermined time depending on which of said switches is actuated.

10. The washing system set forth in claim 1 wherein:
at least one of said arches is formed of somewhat flexible pipe and is supported by spaced apart column members connected to respective ones of the legs of said at least one of said arches.

11. The washing system set forth in claim 1 wherein:
said arches are supported by respective wheel mounted support members connected to respective ones of the legs of said arches for positioning said arches, selectively, with respect to each other and with respect to a location for operation of said washing system.

12. A vehicle washing system comprising:
at least two spaced apart fluid spray arches, each of said arches including spaced apart upstanding fluid conducting legs and fluid conducting transverse members interconnecting said legs, at least said legs including spaced apart spray nozzles disposed thereon for spraying a washing fluid onto a vehicle passing through said arches;
an elongated manifold supported on said transverse member of at least one of said arches and including plural spray nozzles mounted thereon for generating a longitudinal spray pattern for washing vehicles selected from a group consisting of concrete mixer trucks, bulk material tank trucks and bulk material hauling trucks;
a source of liquid washing fluid connected to one of said arches and a source of liquid rinsing fluid connected to the other of said arches; and
control means for conducting washing fluid to said one arch and rinse fluid to said other arch.

13. The washing system set forth in claim 12 including:
a vehicle driver operated control panel including at least one switch for initiating operation of said washing system when a vehicle is driven under said arches, and said control panel is mounted on a support spaced from one of said arches.

14. The washing system set forth in claim 13 wherein:
said source of washing fluid includes a venturi mechanism, and at least one of an acid solution tank and a surfactant solution tank operably connected to said venturi mechanism through respective conduits, and said venturi mechanism is connected to a source of high pressure water for inducting at least one of acid solution and surfactant solution into high pressure water to form said washing fluid.

15. The washing system set forth in claim 14 wherein:
said control panel is operably connected to said control means for operating a motor operated valve to place said source of high pressure water in communication with said venturi mechanism.

16. The washing system set forth in claim 15 wherein:
said control panel includes plural switches operably connected to said control means for initiating operation of said washing system for a predetermined time depending on which of said switches is actuated.

17. A vehicle washing system comprising:
at least two spaced apart fluid spray arches, each of said arches including spaced apart upstanding fluid conducting legs and fluid conducting transverse members extending between said legs, at least said legs including spaced apart spray nozzles disposed thereon for spraying a washing fluid onto a vehicle passing through said arches;
an elongated manifold supported on said transverse member of at least one of said arches and including at least one spray nozzle mounted thereon for generating a longitudinal spray pattern for washing vehicles selected from a group consisting of concrete mixer trucks, bulk material tank trucks and bulk material hauling trucks;
a venturi mechanism, and at least one of an acid solution tank and a surfactant solution tank operably connected to said venturi mechanism through respective conduits, and said venturi mechanism is connected to a source of high pressure water for inducting at least one of acid solution and surfactant solution into high pressure water to form a washing fluid; and
control means for conducting said washing fluid to one arch and rinse fluid to the other arch including a vehicle driver operated control panel including at least one switch for initiating operation of said washing system when a vehicle is driven under said arches, and said control panel is mounted on a support spaced from one of said arches.
